(19) United States
(12) Patent Application Publication
(10) Pub. No.: US 2008/0152152 A1
(43) Pub. Date: Jun. 26, 2008

(54) Sound Image Localization Apparatus

(76) Inventor: Masaru Kimura, Tokyo (JP)

Correspondence Address: BIRCH STEWART KOLASCH & BIRCH, PO BOX 747, FALLS CHURCH, VA, 22040-0747, US

(21) Appl. No.: 11/883,955

(22) PCT Filed: Mar. 9, 2006
(86) PCT No.: PCT/JP06/04626

§ 371 Date: Aug. 8, 2007

(30) Foreign Application Priority Data
Mar. 10, 2005 (JP) 2005-066702

(51) Int. Cl. H04R 5/00

(52) U.S. Cl. 381/17

(57) ABSTRACT

A sound image localization apparatus includes a low band extracting section for extracting a low band signal; a filtering section for filtering the low band signal; a high band extracting section for extracting a high band signal; a gain adjusting section for adjusting gain of the high band signal; and an adding section for adding the output signal of the gain adjusting section and the output signal of the filtering section.

### TECHNICAL FIELD

The present invention relates to a sound image localization apparatus for processing an audio signal.

### BACKGROUND ART

Conventionally, a sound image localization apparatus has been proposed which realizes stereophonic sound by causing a listener to speakers or headphones to localize a sound image as if a sound source were placed at a location (localization target) other than a real sound source that produces the sound in practice. It makes sound pressure from a sound source such as speakers or headphones equal at the eardrums to the sound pressure of the sound fed from a sound source at the localization target by the convolution operation of the head related transfer function (abbreviated to HRTF from now on) measured using a real head or dummy head with an input signal, that is, an audio signal. As a sound image localization apparatus, Japanese patent No. 3267118 discloses a technology that performs the convolution separately with filters after dividing the audio signal to a high frequency band and a low frequency band.

Patent Document 1: Japanese patent No. 3267118;

Patent Document 2: Japanese patent application laid-open No. 312099/1992; and

Patent Document 3: Japanese patent application laid-open No. 2003-230198.

Although the sound image localization apparatus according to Japanese patent No. 3267118 realizes a sound image localization filter by a filter with the tap number less than that of a conventional sound image localization filter, it requires enormous amounts of computations. For example, when the tap number is 0.1 second and the sampling frequency of the input signal is 48000 Hz, a low frequency band filter requires 24000 Hz×2400 taps (24000×0.1 taps)=57 MIPS (million instructions per second). As for the filters, since there is a high frequency band filter besides the low frequency band filter, they require 57 MIPS×2 bands=114 MIPS. In addition, since the HRTF forms a left-right pair, two sound image localization filter processings must be performed to localize a single sound source. Thus, enormous amounts of computations no less than 228 MIPS are required. In particular, to localize a plurality of sound sources, N sound sources require N times the amount of computations.

Therefore an object of the present invention is to realize stereophonic sound in a small amount of computations in the sound image localization.

### DISCLOSURE OF THE INVENTION

The sound image localization apparatus is characterized by including: a high-pass filter for extracting only a high band signal from an input signal; a low-pass filter for extracting only a low band signal from the input signal; a down-sampler section for thinning out the low band signal separated by the low-pass filter; a filtering section for filtering the low band signal output from the down-sampler section with a filter whose filter coefficient is determined in accordance with a head related transfer function in an anechoic room or reverberation room; an up-sampler section for interpolating the low band signal output from the filter; a low-pass filter for eliminating aliasing distortion from the low band signal output from the up-sampler section; a gain adjusting section for adjusting the gain of the high band signal separated by the high-pass filter; and an adding section for adding the high band signal output from the gain adjusting section and the low band signal output from the low-pass filter.

According to the present invention, stereophonic sound can be implemented in a small amount of computations because the apparatus includes the high-pass filter for extracting only the high band signal from the input signal; the low-pass filter for extracting only the low band signal from the input signal; the down-sampler section for thinning out the low band signal separated by the low-pass filter; the filtering section for filtering the low band signal output from the down-sampler section with the filter whose filter coefficient is determined in accordance with the head related transfer function in the anechoic room or reverberation room; the up-sampler section for interpolating the low band signal output from the filter; the low-pass filter for eliminating aliasing distortion from the low band signal output from the up-sampler section; the gain adjusting section for adjusting the gain of the high band signal separated by the high-pass filter; and the adding section for adding the high band signal output from the gain adjusting section and the low band signal output from the low-pass filter.

### BRIEF DESCRIPTION OF THE DRAWINGS

FIG. 1 is a block diagram showing a configuration of the sound image localization apparatus of an embodiment 1 in accordance with the present invention;

FIG. 2 is a block diagram showing a configuration of the sound image localization apparatus of an embodiment 2 in accordance with the present invention;

FIG. 3 is a block diagram showing a configuration of the sound image localization apparatus of an embodiment 3 in accordance with the present invention;

FIG. 4 is a block diagram showing a configuration of the sound image localization apparatus of an embodiment 4 in accordance with the present invention; and

FIG. 5 is a table of combinations of frequencies M, each of which indicates a boundary between a low band and a high band, with sampling frequencies Fs.

### BEST MODE FOR CARRYING OUT THE INVENTION

The best mode for carrying out the invention will now be described with reference to the accompanying drawings to explain the present invention in more detail.

### Embodiment 1

Generally, man perceives the location and direction of a sound source using characteristics of sounds arriving at right and left ears. In the case of about 700 Hz or less, as a factor of perceiving the location and direction of a sound source, a phase difference between right and left is dominant. From about 700 Hz to about 2000 Hz, both amplitude difference and phase difference between right and left are dominant. Beyond that, the amplitude difference between right and left is dominant. The present invention actively utilizes the foregoing auditory characteristics to reduce the amount of computations by controlling in a low band with an FIR filter (finite-impulse response filter) capable of controlling both the phase and amplitude, and in a higher band by providing an amplitude difference by carrying out gain adjustment without using an FIR filter. The following description will be made under the assumption that the frequency indicating the boundary between the low band and high band is M Hz. Here, M refers to the boundary between the low band and high band a user determines when he or she uses the sound image localization apparatus.

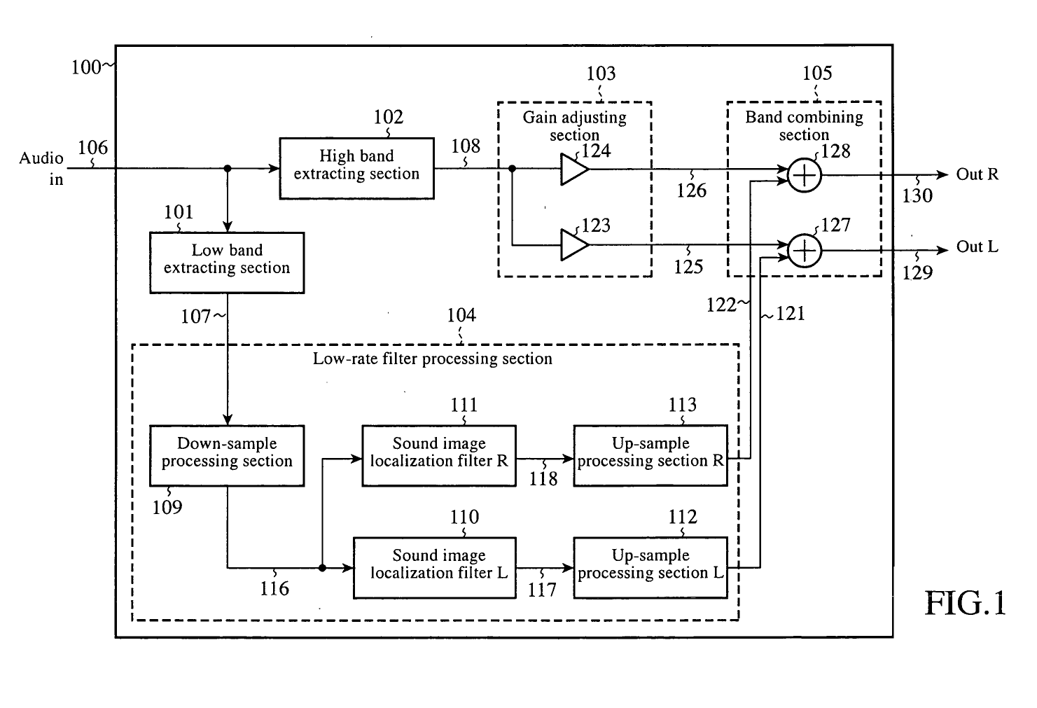

FIG. 1 is a block diagram showing a configuration of a sound image localization apparatus 100 for performing the sound image localization in accordance with the present invention. As shown in FIG. 1, the sound image localization apparatus 100 includes a low band extracting section 101 for extracting a low band signal with a frequency lower than M Hz from an input signal 106 (sampling frequency of Fs Hz); a high band extracting section 102 for extracting a signal in a band from M Hz to Fs/2 Hz inclusive; again adjusting section 103; a low-rate filter processing section 104; and a band combining section 105. The low-rate filter processing section 104 includes a down-sample processing section 109, a left-ear sound image localization filter L 110, aright-ear sound image localization filter R 111, a left-ear up-sample processing section L 112, and a right-ear up-sample processing section R 113. The gain adjusting section 103 includes a left-ear multiplier L 123, and a right-ear multiplier R 124. Outside the sound image localization apparatus 100, an apparatus for supplying an audio signal such as a DVD (Digital Versatile Disk) player, memory and DTV (Desk Top Video) receiver not shown is placed. It supplies the sound image localization apparatus 100 with the input signal 106, an audio digital signal, as the input signal. As an example of the low band extracting section 101, there is a low-pass filter, and as an example of the high band extracting section 102, there is a high-pass filter.

Next, according to FIG. 1, the operation of the sound image localization apparatus 100 will be described. First, the input signal 106 supplied to the sound image localization apparatus 100 is supplied to the low band extracting section 101 and high band extracting section 102. Here, the input signal 106, a monaural time-series signal representing sound, is a sampled signal (sampling frequency of Fs Hz) of the audio signal.

The low band extracting section 101 generates a signal 107 obtained by extracting only the band lower than M Hz from the entire signal band of the signal 106, and supplies the generated signal 107 to the low-rate filter processing section 104.

In the low-rate filter processing section 104, the signal 107 is supplied to the down-sample processing section 109, first. The down-sample processing section 109 reduces the number of samples and outputs a low-rate signal 116. Since the low band extracting section 101 has already limited the signal 107 to the band lower than M Hz, no aliasing distortion will occur by thinning out the samples.

The signal 116 is supplied to the sound image localization filter L 110 and sound image localization filter R 111. The sound image localization filter L 110 and sound image localization filter R 111 perform the sound image localization filtering processing of the signal 116 using the same rate left-and-right-ear sound image localization filter coefficients which have been obtained in advance for the signal 116, and supply the obtained signals 117 and 118 to the up-sample processing section L 112 and up-sample processing section R 113.

Here, the sound image localization filtering processing refers to a convolution processing of the sound image localization filter coefficients with the signal, where the sound image localization filter coefficients are given in accordance with the head related transfer function (abbreviated to HRTF from now on) from the position to be located to the left ear, which is measured in a reverberation room, and with the HRTF from the position to be located to the right ear, which is measured in the reverberation room, to localize the sound image at a particular position.

The up-sample processing section L 112 and up-sample processing section R 113 insert zeros into each sample signal of the signals 117 and 118 to convert them to signals with the same sampling frequency as the original input signal 106, and supply the converted signals 121 and 122 to the band combining section 105.

On the other hand, the high band extracting section 102 generates a signal 108 by extracting only a band from M Hz to Fs/2 Hz inclusive from the entire signal band of the signal 106, and supplies the signal 108 to the gain adjusting section 103.

The input signal 108 is supplied to the multiplier L 123 and multiplier L 124. The signal is multiplied by the coefficients by the multiplier L 123 and multiplier R 124 to be converted to gain adjusted signals 125 and 126. The signals 125 and 126 are supplied to the band combining section 105. Here, the multiplier 123 multiplies the left-ear gain coefficient, and the multiplier 124 multiplies the right-ear gain coefficient. Concrete gain coefficients are determined as follows according to auditory experiments of the inventor.

According to the auditory experiments of the inventor of the present application, it was found that (i) the good acoustics were achieved when the ratio between the right and left gains was equal to the ratio between average powers in the frequency bands corresponding to the right and left HRTFs. In addition, it was found that (ii) when the gain-adjusted signals were presented in the same right and left phases, the localization accuracy deteriorated.

From the experiments, it is preferable that (i) the gain coefficients in the gain adjusting section be made equal to the ratio between average powers in the frequency band corresponding to the HRTFs from the sound source to be localized to the right and left ears. In addition it is preferable that (ii) the right and left gain coefficients be of the opposite sign. Furthermore, the phase of one of the signals can be shifted by 90 degrees by using Hilbert transform.

In the band combining section 105, an adder 127 adds the signal 121 and the signal 125 to combine the bands, thereby calculating a left-ear output signal 129. Likewise, an adder 128 adds the signal 122 and the signal 126 to combine the bands, thereby calculating a right-ear output signal 130. The left-and-right-ear signals 129 and 130 calculated are output to the outside of the apparatus as an output signal.

According to the configuration of the present embodiment, the low-rate filter processing section 104 provides the phase characteristics and amplitude characteristics of the HRTFs to the signal lower than M Hz, and the gain adjusting section 103 performs the localization processing of the sound image on the band from M Hz to Fs/2 inclusive by the gain adjustment. More specifically, in human auditory characteristics, as for the low audio frequency signal having the phase and amplitude characteristics as important factors, both the phase and amplitude are controlled using the sound image localization filters 110 and 111 that reconstruct the HRTFs precisely; and as for the high audio frequency signal having only the amplitude characteristics as important factors, natural and clear stereophonic sound is achieved in a small amount of computations by adjusting the gains with the gain adjusting section 103 that provides the difference of the amplitude characteristics.

Here, the amount of computations in the present invention will be described. It is considered as to the case where the sampling frequency of the input signal is 48000 Hz, the sound image localization filters are set to include 0.1 second reverberation components and M is set at 3000 Hz under the same assumption as described above. In the low-frequency band filter, since the sampling frequency becomes 2×M according to the sampling theorem, it requires 6000 Hz×600 (6000×0.1) taps=3.6 MIPS. Since the HRTF forms a left-right pair, 7.2 MIPS are necessary because two sound image localization filter processings must be carried out to localize the single sound source. In the high frequency band, the gain adjustment requires an amount of multiplication of 0.048 MIPS. Thus, the present embodiment can be completed in the amount of computations of about 7.2 MIPS. In other words, as compared with Japanese patent No. 3267118, which requires 228 MIPS to localize the single sound source, the present invention requires only about 7.2 MIPS. This means that it offers a computation reduction effect by a factor of 31 or more.

In the sound image localization, since the relative amplitude difference between the right and left ears is important in the high-pitched sound, the present processing can prevent the deterioration of the accuracy of the sound image localization as compared with Japanese patent No. 3267118. This was ensured by the auditory experiments. Besides, although the high-frequency band attenuation in the HRTFs and the changes in the amplitude characteristics and phase characteristics have an influence on the sound quality degradation, the present invention can prevent it using the gain adjustment, thereby being able to achieve the sound image localization with high sound quality.

Furthermore, since the present apparatus employs the gain adjusting section 103 instead of the sound image localization filter in the high frequency band, the apparatus can be designed more easily and inexpensive.

Incidentally, in the gain adjusting section 103, the normalization, which is carried out by dividing both the right and left gain coefficients by the gain coefficient whose absolute value is greater between the right and left coefficients, will make is possible to place the greater gain to one. Thus normalizing by dividing both the right and left gain coefficients enables eliminating one of the multipliers. This not only enables further reduction of the amount of computations, but also can prevent the high-frequency attenuation of one of the signals.

Furthermore, according to the auditory experiments of the inventor of the present application, it was found that clear sound image could be presented by adjusting the gains different in the right and left in the signal in the band from 2000 to 3000 Hz or above. Accordingly, setting M at about 2000 to 3000 Hz in particular enables the sound image localization of good sound quality with ease.

Although the foregoing description makes it preferable to set M at 2000 to 3000M Hz, the present invention is not limited to that. For example, from the viewpoint of reducing the amount of computations, it is preferable to use a low-order low-pass filter. The low-order low-pass filter, however, has a rather wide transient band. Thus, it is sometimes preferable to set M at about 4000 Hz to 6000 Hz with leaving a margin when using the low-order low-pass filter.

In addition, the present embodiment can provide low-pass filters (not shown) to the signals 121 and 122 as needed. Although the up-sample processing section L 112 and up-sample processing section R 113 bring about a virtual image of the original signal component on the frequency axis, passing the signals 121 and 122 through the low-pass filters can eliminate the virtual image.

Furthermore, the present embodiment may provide a delay processing section (not shown) to the signals 125 and 126. The delay processing section adjusts the phase of the signal 126 to that of the signal 122, and the phase of the signal 125 to that of the signal 121. This enables the band combining section 105 to suitably combine the signal bands of the original signal 106 over the entire band only by the addition.

### Embodiment 2

The embodiment 1 extracts from the signal 106, the band lower than M Hz with the low band extracting section 101, and the band from M Hz to Fs/2 Hz inclusive with the high band extracting section 102. The present embodiment, however, extracts the band lower than Fs/(2[Fs/2M]) Hz with a low band extracting section 201 which will be described later, and extracts the band from Fs/(2[Fs/2M]) to Fs/2 Hz inclusive with a high band extracting section 202. In addition, the present embodiment extracts one sample from every [Fs/2M] samples in a down-sample processing section 209. Besides, up-sample processing sections 212 and 213 insert [Fs/2M]-1 zeros to each sample. Here, [x] denotes Gauss notation, that is, the maximum integer not exceeding x. Here, the description common to the embodiment 1 will be omitted here.

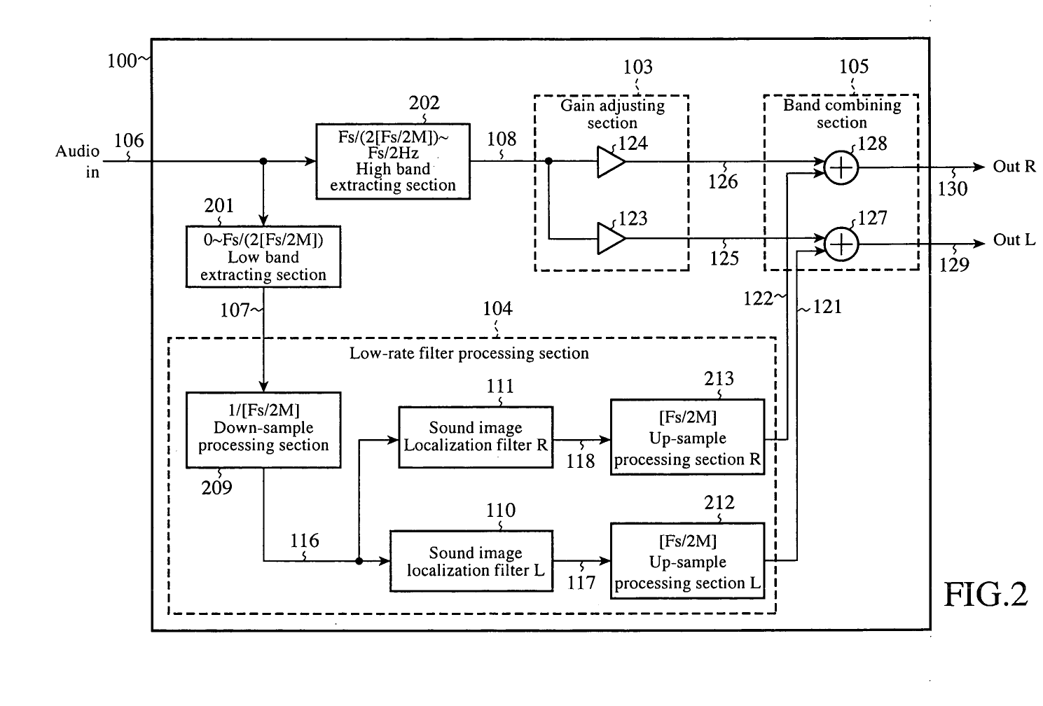

A configuration of the sound image localization apparatus 100 of the present embodiment will be described with reference to FIG. 2. In FIG. 2, the present embodiment 2 differs from the embodiment 1 in that it has the low band extracting section 201, high band extracting section 202, down-sample processing section 209, and up-sample processing sections 212 and 213.

Next, the operation of the sound image localization apparatus 100 of the present embodiment will be described with reference to FIG. 2. First, the signal 106 input to the sound image localization apparatus 100 is supplied to the low band extracting section 201 and high band extracting section 202.

The low band extracting section 201 supplies the low-rate filter processing section 104 with the signal 107 which is obtained by extracting only the low band lower than Fs/(2[Fs/2M]) Hz from the entire signal band of the signal 106. The reasons that the low band extracting section 201 extracts the band lower than Fs/(2[Fs/2M]) Hz are: (i) to carry out the filter processing with limiting to the low frequency band; and (ii) to prevent the down-sample processing section 109, which will be described later, from producing aliasing distortion.

The low-rate filter processing section 104 supplies the signal 107 to the down-sample processing section 209, first. The down-sample processing section 209 extracts one sample from every [Fs/2M] samples to convert to the low-rate signal 116 with a sampling frequency of Fs/[Fs/2M], and supplies it to the sound image localization filters 110 and 111. The reason for extracting one sample from every [Fs/2M] samples is that if the frequency of the signal 107 is M, the sampling frequency of the output signal 116 must be 2M or less in the down-sampling processing. In addition, using the Gauss notation [Fs/2M], the simple operation of thinning out at every fixed sampling interval can achieve the effect of the down-sampling processing.

The sound image localization filters 110 and 111 perform the sound image localization filtering processing using the same rate left-and-right-ear sound image localization filter coefficients which have been obtained in advance for the signal 116, and supply the obtained signals 117 and 118 to the up-sample processing sections 212 and 213.

The up-sample processing sections 212 and 213 insert [Fs/2M]−1 zeros into the samples of the signals 117 and 118. Since the remaining processing is the same as that of the embodiment 1, the description thereof will be omitted here.

According to the configuration of the present embodiment, since the low band extracting section 201 limits the signal 107 to the band lower than Fs/(2[Fs/2M]) Hz, the down-sample processing section 209 does not produce the aliasing distortion even if the samples are thinned out.

In addition, the sampling frequency 1/[Fs/2M] of the original signal 107 can be obtained by the simple operation of extracting one sample from every [Fs/2M]-samples by the down-sample processing section 209.

Furthermore, the band lower than Fs/(2[Fs/2M]) always includes a band lower than M Hz. More specifically, since the band lower than Fs/(2[Fs/2M]) includes the band lower than M Hz without exception, the user can have the low frequency band include M Hz with ease.

In addition, the present embodiment can provide low-pass filters (not shown) to the signals 121 and 122 as needed. Although the up-sample processing section 212 and up-sample processing section 213 bring about a virtual image of the original signal component on the frequency axis, passing the signals 121 and 122 through the low-pass filters can eliminate the virtual image.

Furthermore, the present embodiment may provide a delay processing section (not shown) to the signals 125 and 126. The delay processing section adjusts the phase of the signal 126 to that of the signal 122, and the phase of the signal 125 to that of the signal 121. This enables the band combining section 105 to suitably combine the signal bands of the original signal 106 over the entire band only by the addition.

### Embodiment 3

Although the embodiment 1 is described by way of example that employs the high-pass filter as the high frequency band extracting section 102, for example, the present embodiment employs a delay processing section 302 and a subtracter 304.

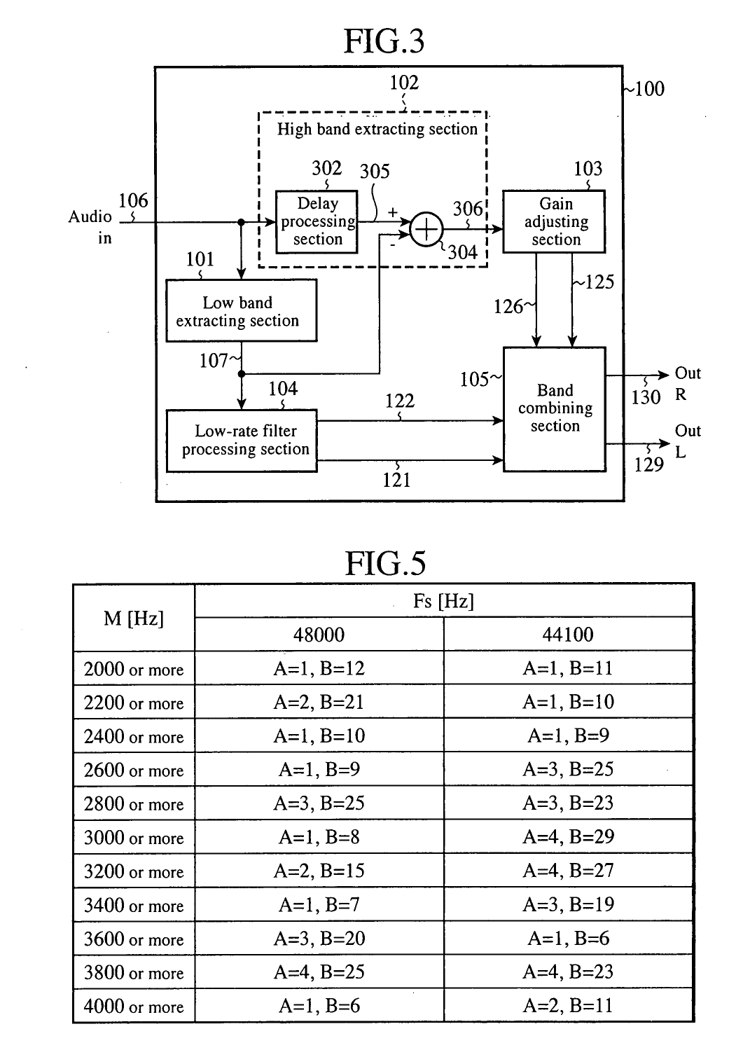

FIG. 3 is a block diagram shown a configuration of the sound image localization apparatus 100 for performing the sound image localization of the present embodiment. The present embodiment differs from the embodiment 1 in that the sound image localization apparatus 100 has the delay processing section 302 and subtracter 304. Here, the description common to the embodiment 1 or 2 will be omitted.

Next, the operation of the sound image localization apparatus 100 will be described with reference to FIG. 3. The signal 106 is input to the delay processing section 302. The delay processing section 302 converts the signal 106 to a signal 305 whose phase is adjusted to the output signal 107 of the low band extracting section 101 consisting of a low-pass filter. The reason for adjusting the phase is that the signal 106 input to the low-band processing section 101 has a delay of an amount corresponding to group delay characteristics due to the low-pass filter. The delay processing section 302 is set in advance in such a manner as to handle the delay of the amount corresponding to the group delay characteristics caused by the low-pass filter.

The subtracter 304 subtracts from the signal 305 the signal 107 passing through the low band extracting section 101. The subtraction gives the signal component interrupted by the low band extracting section 101 in the entire band of the signal 305. Since the low band extracting section 101 blocks the band other than the band lower than M Hz, the signal 306 consist of a signal in the band of M Hz or greater in the signal 305. The signal 306 generated by the subtracter 304 in this way is supplied to the gain adjusting section 103. Since the processing subsequent to the gain adjusting section 103 is the same as that of the embodiment 1 or 2, the description thereof will be omitted here.

Realizing the method of extracting the band of M Hz and above with the high-pass filter will bring about an increase in the amount of computations. However, with the configuration of the present embodiment, which implements the extraction of the band of M Hz and above with the delay processing section 302 and subtraction processing section 304, the same effect as the high-pass filter can be obtained in a smaller amount of computations.

Incidentally, the present embodiment can provide low-pass filters (not shown) to the signals 121 and 122 as needed. Although the up-sample processing section 112 and up-sample processing section 113 bring about a virtual image of the original signal component on the frequency axis, passing the signals 121 and 122 through the low-pass filters can eliminate the virtual image.

Furthermore, the present embodiment may provide a delay processing section (not shown) to the signals 125 and 126. The delay processing section adjusts the phase of the signal 126 to that of the signal 122, and the phase of the signal 125 to that of the signal 121. This enables the band combining section 105 to suitably combine the signal bands of the original signal 106 over the entire band only by the addition.

### Embodiment 4

In the embodiment 1, although the high band extracting section 102 extracts the frequency band from MHz to Fs/2 inclusive, the present embodiment extracts the frequency band from Fs×(A/2B) to Fs/2 inclusive. In addition, although the embodiment 1 performs the filtering processing on the signal 107 the low band extracting section 101 extracts, the present embodiment has a low band extracting section 405 extract a low band from a signal 404 passing through an A-times-up-sampling processing in advance, and performs the filtering processing on the low band signal.

Here, the integers A and B are determined as follows, for example. More specifically, Fs/2M is placed at B/A, and B/A is simplified to a ratio of integers. For example, when Fs=48000 Hz and M=3200 Hz, Fs/2M=48000/(2×3200)=15/2, and hence B=15 and A=2.

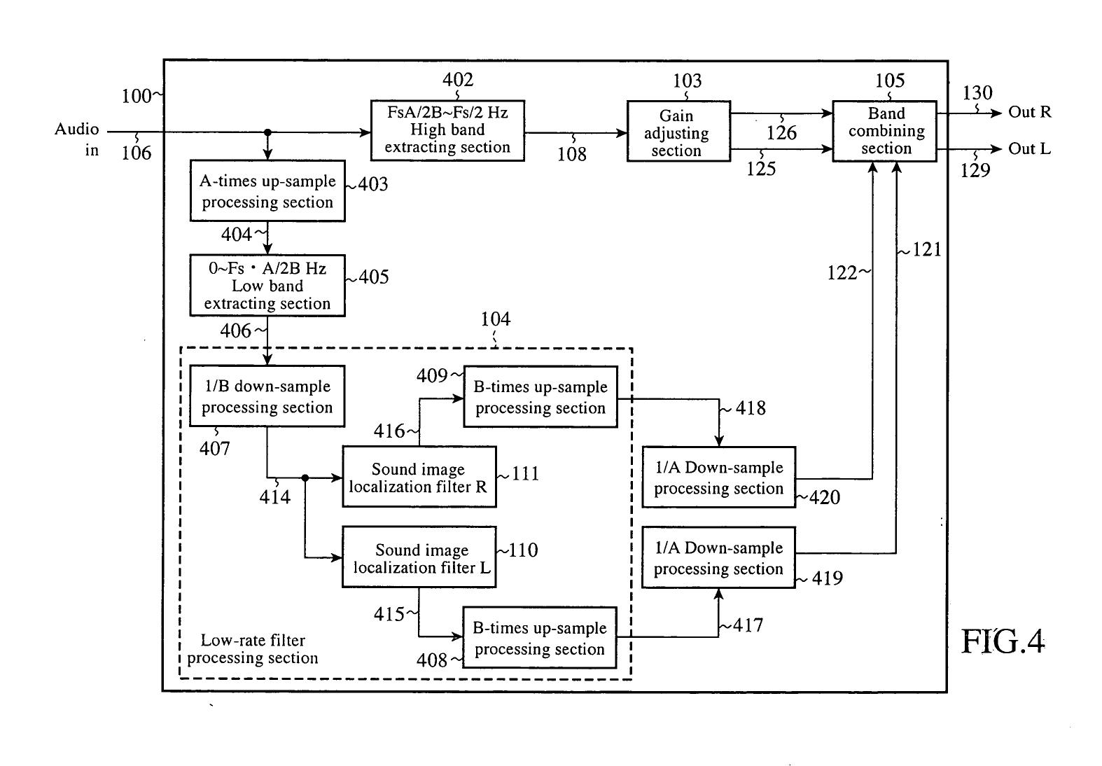

FIG. 4 is a block diagram showing the sound image localization apparatus 100 for achieving the sound image localization in the present embodiment. In FIG. 4, the sound image localization apparatus 100 includes a high band extracting section 402 for extracting the band from Fs×(A/2B) to Fs/2 Hz inclusive; an up-sample processing section 403 for carrying out A-times-up-sampling processing of the signal; a low band extracting section 405 for extracting the band of Fs×(A/2B) Hz and below; a down-sample processing section 407 for carrying out 1/B-times-down-sampling processing of the signal; up-sample processing sections 408 and 409 for carrying out B-times-up-sampling processing of signals; and down-sample processing sections 419 and 420 for carrying out 1/A-times-down-sampling processing of the signals. Here, the description common to the embodiments 1-3 will be omitted.

Next, the operation of the sound image localization apparatus 100 will be described with reference to FIG. 4. First, the signal 106 is input to the up-sample processing section 403. The up-sample processing section 403 inserts (A−1) zeros to each sample of the signal 106, and generates a signal 404 with A times the sampling frequency. Subsequently, the signal 404 is input to the low band extracting section 405. The low band extracting section 405 extracts a signal 406 with a band of Fs×(A/2B) Hz or less from the signal 404 to eliminate aliasing distortion.

Subsequently, the signal 406 is input to the down-sample processing section 407. The down-sample processing section 407 extracts one sample from every B samples to make the sampling frequency of the signal 406 1/B times, and generates a signal 414. In this case, since the up-sample processing section 403 makes the sampling frequency of the signal 406 Fs×A, the sampling frequency of the signal 414 becomes Fs×(A/B) through the down-sampling processing. In addition, since the low band extracting section 405 limits the band of the signal 406 to Fs×(A/2B) or less, the down-sampling processing does not cause aliasing distortion even through the samples are thinned out.

The signal 414 is supplied to the left-ear sound image localization filter 110 and to the right-ear sound image localization filter 111. The left-and-right-ear sound image localization filters 110 and 111 carry out the sound image localization filtering processing according to the left-and-right-ear sound image localization filter coefficients with the same rate which is obtained in advance for the signal 414. Signals 415 and 416 generated by the processing are supplied to the up-sample processing sections 408 and 409, respectively.

The up-sample processing sections 408 and 409 insert (B−1) zeros to each sample of the signals 415 and 416, and convert them to signals with the B-times sampling frequency. Then, they supply the converted signals 417 and 418 to the down-sample processing sections 419 and 420, respectively. The down-sample processing sections 419 and 420 extract one sample from each A samples of the signals 412 and 413 to reduce the sampling frequency of the signal to 1/A. The foregoing processing causes the signals 121 and 122 to have the same sampling frequency as the audio signal 106. The signals 121 and 122 obtained are supplied to the band combining section 105. Since the remaining processing is common to that of the embodiments 1-3, the description thereof will be omitted here.

According to the configuration of the present embodiment, since the low band extracting section 405 limits the signal 406 to the band lower than Fs×(A/2B) Hz, the down-sample processing section 407 can prevent the aliasing distortion in spite of the thinning out of the samples.

As for B, it is always an integer. Accordingly, the down-sample processing section 407 can carry out the down-sampling processing by simple operation of thinning out one sample from every B samples. Thus, it can implement the down-sampling processing in a small amount of computations.

In addition, the configuration of the embodiment makes it possible to carry out the filter processing at a lower sampling frequency, which is a frequency at the border between the high band extracting section and the low band extracting section. Thus, it can carry out the sound image localization filtering processing in a smaller amount of computations. To be concrete, when Fs=48000 Hz and M=3200 Hz, in the embodiment 2, since [Fs/2M]=7, the sampling frequency of the low-rate filter processing section is about 24000/7=3428 Hz in the low band extracting section. In the present embodiment, however, by placing A=2 and B=15, the sampling frequency of the low-rate filter processing section can be made 24000×( 2/15)=3200 Hz. Thus, the present embodiment can carry out the filter processing at the lower sampling frequency, which is the frequency at the border between the high band extracting section and the low band extracting section. More specifically, when a 0.1-second sound image localization filter is employed, the amount of computations the sound image localization filter of the low-rate filter processing section takes is 6875 Hz×688 taps=4.73 MIPS in the embodiment 2, and is 6400 Hz×640 taps=4.1 MIPS in the present embodiment. Thus, the present embodiment can implement a smaller amount of computations.

Incidentally, the present embodiment can provide low-pass filters (not shown) to the signals 417 and 418 as needed. Providing the low-pass filters behind the up-sampling processing sections 408 and 409 can eliminate the aliasing distortion by allowing only the low-band components of the signals 417 and 418 to pass through, and can supply the signals without the aliasing distortion to the down-sample processing sections 419 and 420.

Furthermore, the present embodiment may provide a delay processing section (not shown) to the signals 125 and 126. By providing the delay processing section, the phase of the signal 126 is adjusted to that of the signal 122, and the phase of the signal 125 to that of the signal 121. This enables the band combining section 105 to suitably combine the signal bands of the original signal 106 over the entire band only by the addition.

The present embodiment is described by way of example that assumes Fs=48000 Hz and M=3200 Hz, and that places Fs/2M at B/A and simplifies B/A to the ratio of integers. However, Fs varies its frequency depending on whether the present embodiment is applied to a DVD or CD, and M varies depending on the user's choice. Accordingly, A and B must be determined in accordance with the values Fs and M as shown in FIG. 5, for example. More specifically, according to FIG. 5, when M is 2000 Hz and Fs is 48000 Hz, the values A=1 and B=12 are taken. Obviously, the values in the table are an example, and the values A and B can take different values than those of the table.

### INDUSTRIAL APPLICABILITY

As described above, the sound image localization apparatus in accordance with the present invention is suitable for realizing the stereophonic sound in a smaller amount of computations in the sound image localization.

What is claimed is:

1. A sound image localization apparatus comprising:
a low band extracting section for extracting a low band signal from an input signal;
a filtering section for filtering the low band signal extracted by said low band extracting section in accordance with a head related transfer function;
a high band extracting section for extracting a high band signal from the input signal;
a gain adjusting section for adjusting gain of the high band signal extracted by said high band extracting section; and
an adding section for adding the high band signal output from said gain adjusting section and the low band signal output from said filtering section.

2. A sound image localization apparatus comprising:
a low band extracting section for extracting a low band signal from an input signal;
a down-sample processing section for thinning out the low band signal extracted by said low band extracting section at fixed intervals;
a filtering section for filtering the low band signal output from said down-sample processing section in accordance with a head related transfer function;
an up-sample processing section for carrying out interpolation processing of the low band signal output from said filtering section;
a high band extracting section for extracting a high band signal from the input signal;
a gain adjusting section for adjusting gain of the high band signal extracted by said high band extracting section; and
an adding section for adding the high band signal output from said gain adjusting section and the low band signal output from said up-sample processing section.

3. A sound image localization apparatus comprising:
a low band extracting section for extracting a low band signal from an input signal;
a down-sample processing section for thinning out the low band signal extracted by said low band extracting section at fixed intervals;
a first filtering section for filtering the low band signal output from said down-sample processing section in accordance with a head related transfer function corresponding to the left ear of a listener;
a first up-sample processing section for carrying out interpolation processing of the low band signal output from said first filtering section;
a second filtering section for filtering the low band signal output from said down-sample processing section in accordance with a head related transfer function corresponding to the right ear of the listener;
a second up-sample processing section for carrying out interpolation processing of the low band signal output from said second filtering section;
a high band extracting section for extracting a high band signal from the input signal;
a first gain adjusting section for adjusting gain of the high band signal extracted by said high band extracting section for the left ear of the listener;
a second gain adjusting section for adjusting the gain of the high band signal extracted by said high band extracting section for the right ear of the listener;
a first adding section for adding the high band signal output from said first gain adjustment section and the low band signal output from said first up-sample processing section; and
a second adding section for adding the high band signal output from said second gain adjustment section and the low band signal output from said second up-sample processing section.

4. A sound image localization apparatus comprising:
a low band extracting section for extracting a low band signal lower than Fs/(2[Fs/2M]) Hz from an input signal with a sampling frequency Fs in accordance with a predetermined integer M;
a down-sample processing section for extracting one sample at every [Fs/2M] interval from the low band signal extracted by said low band extracting section;
a filtering section for filtering the low band signal output from said down-sample processing section in accordance with a head related transfer function;
an up-sample processing section for interpolating [Fs/2M]−1 zeros to each sample output from said filtering section;
a high band extracting section for extracting a signal with a band of Fs/(2[Fs/2M]) Hz and above from the input signal;
a gain adjusting section for adjusting gain of the high band signal extracted by said high band extracting section; and
an adding section for adding the high band signal output from said gain adjusting section and the low band signal output from said up-sample processing section.

5. The sound image localization apparatus according to claim 1, wherein said low band extracting section consists of a low-pass filter, and said high band extracting section comprises:
a delay processing section for delaying the input signal by an amount corresponding to group delay characteristics caused by said low-pass filter in response to the low band signal output from said low-pass filter; and
a subtracter for subtracting the low band signal output from said low band extracting section from the signal output from said delay processing section.

6. A sound image localization apparatus comprising:
a low band extracting section for extracting a low band signal from an input signal;
a down-sample processing section for thinning out the low band signal extracted by said low band extracting section at every fixed integer sampling frequencies;
a filtering section for filtering the low band signal output from said down-sample processing section in accordance with a head related transfer function;
an up-sample processing section for carrying out interpolation processing of the low band signal output from said filtering section;
a high band extracting section for extracting a high band signal from the input signal;
a gain adjusting section for adjusting gain of the high band signal extracted by said high band extracting section; and
an adding section for adding the high band signal output from said gain adjusting section and the low band signal output from said up-sample processing section.

7. The sound image localization apparatus according to claim 1, further comprising a delay processing section for delaying the high band signal output from said gain adjusting section by an amount corresponding to group delay characteristics in response to the signal output from said filtering section.

8. The sound image localization apparatus according to claim 2, further comprising a delay processing section for delaying the high band signal output from said gain adjusting section by an amount corresponding to group delay characteristics in response to the signal output from said filtering section.

9. The sound image localization apparatus according to claim 3, further comprising a delay processing section for delaying the high band signal output from said gain adjusting section by an amount corresponding to group delay characteristics in response to the signal output from said filtering section.

10. The sound image localization apparatus according to claim 4, further comprising a delay processing section for delaying the high band signal output from said gain adjusting section by an amount corresponding to group delay characteristics in response to the signal output from said filtering section.

11. A sound image localization method comprising:
a low band extracting step of extracting a low band signal from an input signal;
a filtering step of filtering the low band signal extracted at the low band extracting step in accordance with a head related transfer function;
a high band extracting step of extracting a high band signal from the input signal;
a gain adjusting step of adjusting gain of the high band signal extracted at the high band extracting step; and
an adding step of adding the high band signal output from the gain adjusting step and the low band signal output from the filtering step.
